(19) United States
(12) Patent Application Publication
(10) Pub. No.: US 2007/0011745 A1
(43) Pub. Date: Jan. 11, 2007

(54) Recording medium recording worm detection parameter setting program, and worm detection parameter setting device

(75) Inventors: Masashi Mitomo, Kawasaki (JP); Yoshiki Higashikado, Kawasaki (JP); Masahiro Komura, Kawasaki (JP); Bintatsu Noda, Kawasaki (JP); Kazumasa Omote, Kawasaki (JP); Satoru Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/376,083

(22) Filed: Mar. 16, 2006

(30) Foreign Application Priority Data
Jun. 28, 2005 (JP) JP 2005-189014

(51) Int. Cl. G06F 12/14

(52) U.S. Cl. 726/24; 726/22

(57) ABSTRACT

A computer-readable recording medium recording a worm detection parameter setting program for setting an appropriate worm detection parameter for target environments. When a log reader loads a communication log created within a prescribed time period, a log classifier classifies the entries of the communication log into categories based on communication contents. A frequency distribution creator analyzes the entries of a category, counts the number of appearance of each worm detection parameter value for each object of a preset network unit, and creates frequency distribution information. A threshold derivation unit analyzes the frequency distribution information and derives a threshold value that is used for determining whether a worm is propagating. An output unit outputs to an output device the threshold value for the worm detection parameter for the category, together with the frequency distribution information created by the frequency distribution creator, thereby providing a user with the information.

### CROSS-REFERENCE TO RELATED APLICATIONS

This application is based on, and claims priority to, Japanese Application No. 2005-189014, filed on Jun. 28, 2005, in Japan, and which is incorporated herein by reference.

### BACKGROUND OF THE INVENTION

(1) Field of the Invention

This invention relates to a recording medium recording a worm detection parameter setting program and a worm detection parameter setting device, and more particularly, to a recording medium recording a worm detection parameter setting program and a worm detection parameter setting device, for setting a worm detection parameter that is used for determining whether a worm is propagating.

(2) Description of the Related Art

With expansion of networks because of the spread of the Internet, computer virus causes more damage by successively infecting computers over the networks.

Out of the computer virus, a worm makes distribution of copies of itself, thereby infecting computers one after another over networks very fast. Because of the distribution of copies, the worm makes a large amount of traffic, which causes loads on the networks and may cause network paralysis and slowdown of processing speed. In addition, since the worm infects computers successively, its damage cannot be prevented only by searching for worm-infected computers and breaking the worm. Therefore, it is crucial to detect worms by monitoring traffic entering a network at a border of the network.

To detect worms early, a technique of monitoring network traffic and detecting abnormal communication as worm communication has been proposed. For example, worm-infected terminals randomly make access requests to not only existing destinations but also unexisting destinations. Therefore, the number of accesses to unexisting sub-networks per unit time is set as a worm detection parameter for worm detection together with a threshold value separating between normal communication and worm communication. Then the network traffic is monitored. When a worm detection parameter value exceeds the threshold value, it is determined that a worm is appearing. However, such a threshold value is difficult to set since an appropriate threshold value is different depending on system configuration, a traffic amount, a time zone (day time with a large traffic amount or night time with a small traffic amount), existence or absence of a specific event. In prior art, a threshold value is obtained in such a manner that a communication log of normal state is analyzed to calculate a range of worm detection parameter values for the normal state and a certain value beyond the range is set as the threshold vale.

In addition, an irruption/detection device for creating profiles of normal communication from past communication results and detecting illegal accesses or abnormal accesses based on a similarity degree to the profiles has been proposed (for example, refer to Japanese Unexamined Patent Publication No. 2004-186878, paragraph Nos. [0034]-[0043], FIG. 1).

The prior technique has a drawback in that a worm detection parameter suitable for a target environment is difficult to set.

The technique of detecting worms based on whether a worm detection parameter value exceeds a threshold value may have adverse effects on a network system if the threshold value is not appropriately set. A low threshold value decreases a rate of missing detection of worm communication but increases a rate of erroneously detecting normal communication as worm communication. As a result, unnecessary alarm may ring and normal communication lines may be shut down. A high threshold value, on the other hand, decreases the rate of erroneous worm detection but increases the rate of missing worm detection.

It is recognized that a threshold value for a worm detection parameter should be set carefully since it directly relates to detection accuracy. However, since an appropriate value for the worm detection parameter varies depending on a traffic amount of a target network and the number of hosts, the appropriate value is difficult to set. Here, the a worm detection parameter may be the number of accesses or an appearance frequency of prescribed packets per prescribed unit time. If the unit time is not appropriately set, an appropriate threshold value separating between normal communication and worm communication may not be set, with the result that erroneous worm detection or missing of worm detection may occur.

The prior technique of calculating a range of worm detection parameter values for normal communication and setting a threshold value has a drawback in that change of the range due to transient causes changes of the threshold value and thus an appropriate threshold value for a target environment cannot be set. In addition, it is considered that if a worm appears, the amount of communication increases because a large number of impropriety communication packets are sent. However, it cannot be predicted from the profiles of the normal communication how much the amount of communication increases. Therefore, if the profiles or the threshold value are set for worm detection only based on the normal profiles, an appropriate value may not be set.

### SUMMARY OF THE INVENTION

This invention has been made in view of foregoing and intends to provide a recording medium recording a worm detection parameter setting program and a worm detection parameter setting device, for enabling setting of a worm detection parameter suitable for a target environment.

To accomplish this object, provided is a computer-readable recording medium recording a worm detection parameter setting program for setting a worm detection parameter to be used for determining whether a worm is propagating. This worm detection parameter setting program recorded in the recording medium causes a computer to function as: a log classifier for classifying entries of a communication log created within a prescribed time period, into preset categories based on communication contents when the communication log is loaded; a frequency distribution creator for calculating a worm detection parameter value per preset unit time, for each object of a preset network unit, based on the entries of a category, counting an appearance frequency of each worm detection parameter value, and creating frequency distribution information; a threshold derivation unit for analyzing the frequency distribution information created by the frequency distribution creator, and deriving a threshold value for the worm detection parameter to be used for determining whether the worm is propagating; and an output unit for outputting to a prescribed output device the worm detection parameter including the derived threshold value, together with the frequency distribution information created by the frequency distribution creator.

Further, to accomplish the object, there provided a worm detection parameter setting device for setting a worm detection parameter to be used for determining whether a worm is propagating. This worm detection parameter setting device comprises: a log classifier for classifying entries of a communication log created within a prescribed time period, into preset categories based on communication contents when the communication log is loaded; a frequency distribution creator for calculating a worm detection parameter value per preset unit time, for each object of a preset network unit, based on the entries of a category, counting an appearance frequency of each worm detection parameter value, and creating frequency distribution information; a threshold derivation unit for analyzing the frequency distribution information created by the frequency distribution creator, and deriving a threshold value for the worm detection parameter to be used for determining whether the worm is propagating; and an output unit for outputting to a prescribed output device the worm detection parameter including the derived threshold value, together with the frequency distribution information created by the frequency distribution creator.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of this invention that is implemented to one embodiment.

FIG. 2 shows a configuration of a network system according to the embodiment of this invention.

FIG. 3 is a block diagram of a hardware configuration of a worm detection parameter setting device 10 according to the embodiment.

FIG. 4 is a flowchart of a worm detection parameter setting procedure according to the first embodiment.

FIG. 5 shows an example of a display screen displaying a frequency distribution table and a result according to the first embodiment.

FIG. 6 is a flowchart of a worm detection parameter setting procedure according to the second embodiment.

FIG. 7 shows an example showing how to derive a threshold value according to the second embodiment.

FIG. 8 shows an example showing how to derive a threshold value in a case where normal communication and worm communication have overlapping frequency distributions according to the second embodiment.

FIG. 9 is a flowchart showing an example of a threshold derivation procedure using a threshold determination policy according to the second embodiment.

FIG. 10 shows an example showing how to derive a threshold value based on detection accuracy according to the second embodiment.

FIG. 11 is a flowchart of a threshold derivation procedure using detection accuracy according to the second embodiment.

FIG. 12 shows an example showing how to derive a threshold value based on frequency distribution tables created for some choices of unit time according to the second embodiment.

FIG. 13 is a flowchart of a threshold derivation procedure using the frequency distribution tables created for some choices of unit time according to the second embodiment.

### DESCRIPTION OF THE PREFERRED EMBODIMENTS

Preferred embodiments of this invention will be described with reference to the accompanying drawings. The invention to be implemented to the embodiments will be first outlined and then the embodiments will be described in detail.

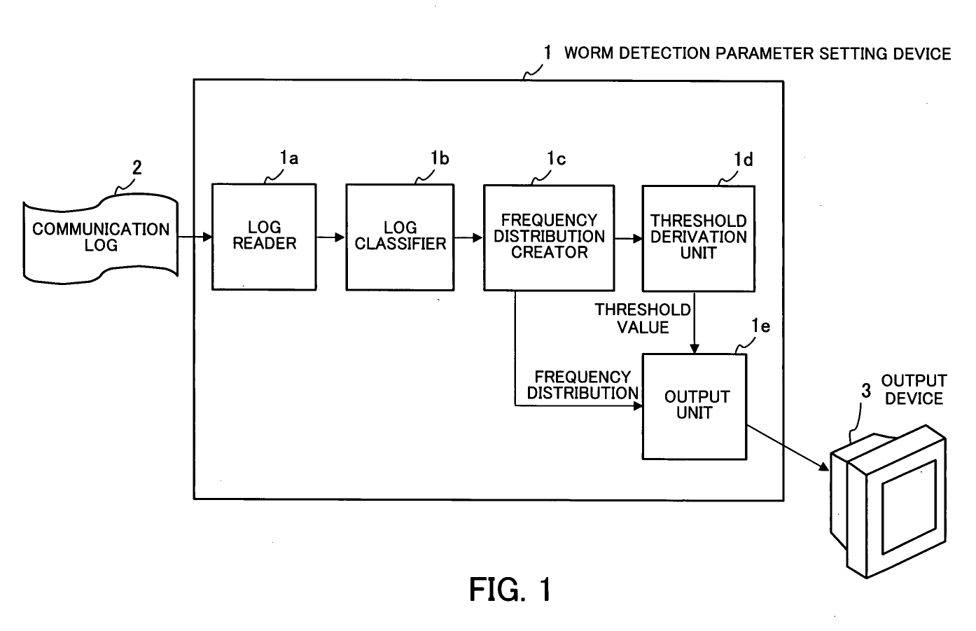

FIG. 1 is a conceptual view of this invention which is implemented to the embodiments. A worm detection parameter setting device 1 is connected to an output device 3, and is designed to load a communication log 2 of network traffic created within a prescribed time period and output to the output device 3 a set value for a worm detection parameter and frequency distribution information used for determining the set value in order to inform a user.

The worm detection parameter setting device 1 has a log reader 1a, a log classifier 1b, a frequency distribution creator 1c, a threshold derivation unit 1d and an output unit 1e. These processing units operate their functions while the device runs a worm detection parameter setting program.

The log reader 1a loads the communication log 2 created within the prescribed time period and gives it to the log classifier 1b. Such a communication log 2 comprises many entries and is created by capturing packets traveling over a target network for a certain time period with an existing packet analyzer or the like installed in the target network and creating the entries each representing a packet. Each entry shows communication information, such as source and destination addresses, source and destination ports, and protocol. As the communication log 2, one kind or some kinds of communication logs, such as a normal communication log and/or a worm communication log, may be appropriately selected and loaded. In addition, the communication log 2 can be previously created or can be created from network traffic in real-time.

The log classifier 1b classifies the entries of the communication log 2 received from the log reader 1a, into preset categories based on communication contents, such as protocol (TCP/UDP/ICMP), service (destination port number), flag included in packet (only SYN packet in TCP), or another property of packet. Since worms of same kind do not create various kinds of communication randomly but perform a lot of communication of same category, the categorization is first performed and then frequency distribution information is created. This reduces a possibility of erroneously identifying normal communication as worm communication. The categorization may not be performed so as to process all entries.

The frequency distribution creator 1c calculates a value of a worm detection parameter per preset unit time based on the categorized entries of the communication log 2, for each object of a preset network unit, counts from the calculated values the number (an appearance frequency) of each value, and creates frequency distribution information. In this connection, the preset network unit is a unit for creating a frequency distribution, and may be network segment or terminal. In a case of counting the number of packets for each terminal, for example, the categorized entries of the communication log are analyzed to count the number of entries that show the same source address per preset unit time. This process is applied for all source addresses, and an appearance frequency in a class interval of the worm detection parameter corresponding to the counted number of entries is incremented by one. As the worm detection parameter, an item which greatly varies when a worm is propagating, as compared with the normal state, is set. For example, the number of packets (the number of entries in a communication log), a communication amount (a data transfer amount per unit time), the number of destination addresses, or the number of source addresses can be used. A combination of one or more items may be set. In addition, the unit time for calculating appearance frequency and the class intervals of the worm detection parameter for creating a frequency distribution are desirably set suitably for a target network.

The threshold derivation unit 1d analyzes the frequency distribution information of each worm detection parameter value created by the frequency distribution creator 1c, and derives a threshold value separating between worm communication and normal communication. In this connection, a threshold derivation rule is set according to a used communication log (normal communication log or worm communication log), and target network's property (for example, which does not permit missing worm detection or erroneous worm detection). A derivation logic can be described as a threshold determination policy. Note that some logics may be prepared so as to let the user select from among them.

The output unit 1e outputs to the output device 3 the frequency distribution information created by the frequency distribution creator 1c and the worm detection parameter including the threshold value derived based on the frequency distribution information by the threshold derivation unit 1d, in order to provide the user with the information. When the output device 3 is a display device, the output unit 1e outputs display information so as to display the information on a display screen. When the output device 3 is a printer, the output unit 1e outputs printing information. In this way, the output unit 1e creates output information according to the output device 3 and outputs the output information.

Next explanation is about how the worm detection parameter setting device 1 works.

Before the worm detection parameter setting device 1 starts the worm detection parameter setting process, a communication log 2 is created from a target network, the communication log indicating normal network traffic of the target network. In addition, if necessary, a communication log indicating worm communication may be created in order to clarify differences between the normal state and the worm state. Thus obtained communication log 2 is loaded by the log reader 1a. The log classifier 1b classifies the entries of the loaded communication log 2 into categories based on communication contents. Based on the entries of each category, the frequency distribution creator 1c creates frequency distribution information regarding a worm detection parameter per preset unit time, for each object of a preset network unit.

As an example, assume that “10 seconds”, “terminal”, and “the number of packets per unit time” are set as a unit time, a network unit, and a worm detection parameter, respectively, and a frequency distribution has “10 class intervals”. In this case, the entries within 10 seconds in a communication log are categorized based on terminal (source IP address), and the number of detected packets (the number of entries of the communication log) is counted for each terminal. This is under an assumption that an entry is created for each packet and therefore the number of packets is equal to the number of entries. Thus “the number of packets per unit time” that is a worm detection parameter is calculated for each terminal. Then the appearance frequency in a class interval of the parameter corresponding to each counted number is incremented by one. For example, in a case where the number of packets per unit time is 20, the appearance frequency (appearance number of times) in a class interval “11-20” created by grouping in class intervals of 10 each is incremented by one. The same process is performed for the other objects (terminals) of the network unit. By performing the above process on the entries for every 10 seconds in the communication log, frequency distribution information can be created, which indicates a distribution of the number of packets that were sent from each terminal for 10 seconds and fall in the preset category.

Then the threshold derivation unit 1d derives a threshold value from the frequency distribution information created by the frequency distribution creator 1c under a predetermined rule. The output unit 1e outputs to the output device 3 set information for the worm detection parameter including the threshold value derived by the threshold derivation unit 1d, together with the frequency distribution information created by the frequency distribution creator 1c. When the output device 3 is a display device, the output unit creates and outputs display information for displaying on a screen the set value for the worm detection parameter and the frequency distribution information in a table.

As described above, frequency distribution information indicating a distribution of worm detection parameter values is created for worm detection based on a communication log of a target network created for worm detection, and a threshold value is obtained from the frequency distribution information, so that even unskilled user can set an appropriate threshold value for the target network. In addition, the frequency distribution information used for deriving the threshold value is provided together with the threshold value, so as to allow the user to determine whether the threshold value is appropriate. Since the worm detection using such a worm detection parameter is based on the worm's behavior, this invention has features in that even unknown worms can be detected and worms can be detected early. On the other hand, since a parameter value such as the number of packets per unit time may vary due to causes other than worm communication, transitory elements unrelating to worm communication cannot be prevented from being introduced into frequency distribution information. Therefore, the frequency distribution information used for determining the threshold value is provided together with the threshold value, so that the user can determine with reference to the frequency distribution information whether the threshold value is appropriate.

As a result, an appropriate worm detection parameter for a target environment can be set easily.

One embodiment of this invention will be described in detail in terms of an example where a worm detection parameter is set to a worm detection/interruption device installed in a network segment.

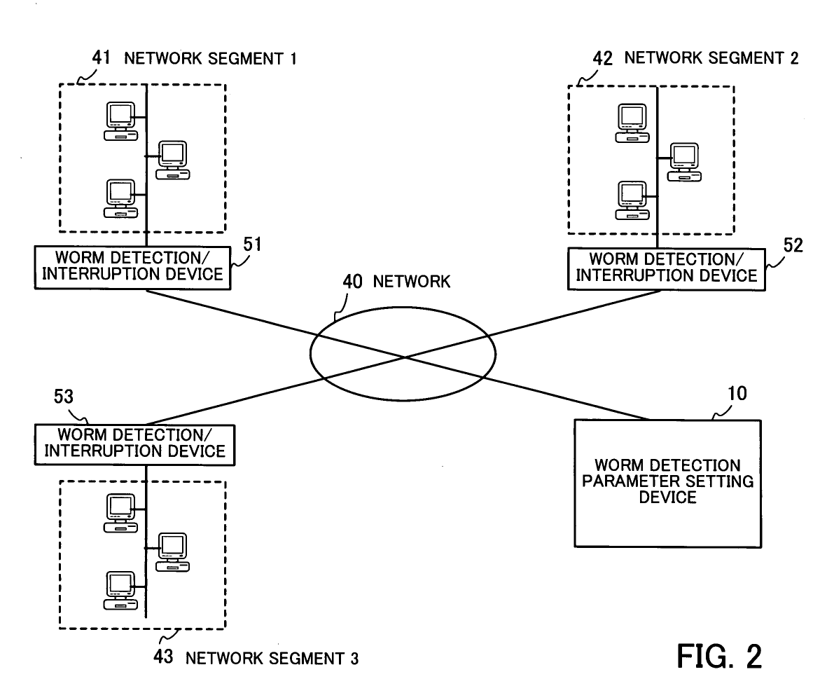

FIG. 2 shows a configuration of a network according to this embodiment of this invention.

In the network according to this embodiment, network segments 1 (41), 2 (42), and 3 (43) each having at least one terminal are connected to each other over a higher-ranked network 40, and worm detection/interruption devices 51, 52 and 53 are installed at the connecting points of the network segments 41, 42 and 43 and the higher-ranked network 40. The higher-ranked network 40 may be the Internet, intranet, or ISP network.

Each worm detection/interruption device 51, 52, 53 monitors packets entering into a segment being managed by its own device and packets going to the higher-ranked network 40, and when a worm detection parameter value such as the number of packets exceeds a threshold value, determines that a worm is propagating and shuts a communication line according to necessity. This technique requires a shorter processing time as compared with a technique of comparing each packet with registered attack pattern information. Therefore, this technique has features of enabling checking of all packets, early worm detection, and unknown-worm detection.

A worm detection parameter setting device 10 according to this embodiment of this invention is connected to each worm detection/interruption device 51, 52, 53 over the network 40, and is designed to obtain the communication log of each network segment, set an appropriate value for a worm detection parameter, and reflect this value to the worm detection parameter registered in the worm detection/interruption device 51, 52, 53. Note that the worm detection parameter setting device 10 may not be connected to the network 40 if this device 10 can obtain the communication log of each network segment. In addition, the set value determined by the worm detection parameter setting device 10 can be directly set by the user to a corresponding worm detection/interruption device 51, 52, 53, without being transmitted over the network 40.

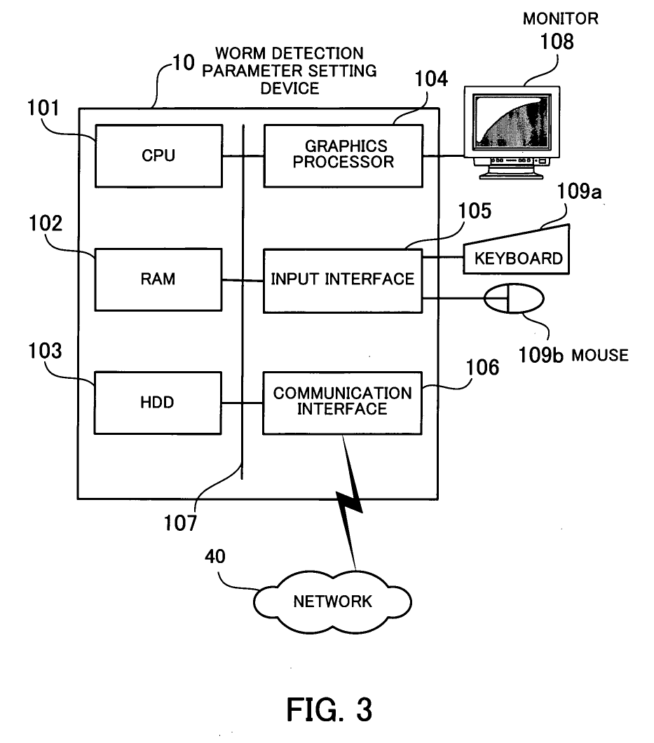

The hardware configuration of the worm detection parameter setting device 10 will be described with reference to FIG. 3.

The worm detection parameter setting device 10 is entirely controlled by a Central Processing Unit (CPU) 101. Connected to the CPU 101 via a bus 107 are a Random Access Memory (RAM) 102, a Hard Disk Drive (HDD) 103, a graphics processing unit 104, an input device interface 105, and a communication interface 106.

The RAM 102 temporarily stores at least part of the Operating System (OS) program and application programs to be executed by the CPU 101. In addition, the RAM 102 stores various kinds of data for CPU processing. The HDD 103 stores the OS and application programs. The graphics processing unit 104 is connected to a monitor 108 to display images on the monitor 108 under the control of the CPU 101. The input device interface 105 is connected to a keyboard 109a and a mouse 109b to transfer signals from the keyboard 109a and the mouse 109b to the CPU 101 via the bus 107. The communication interface 106 is connected to the network 40, and is designed to communicate data with other devices such as worm detection/interruption devices via the network 40.

The above hardware configuration realizes the processing functions of this invention.

The worm detection parameter setting device 10 obtains at least a communication log indicating the normal state (no worm communication) of a target network segment, and sets a threshold value based on frequency distribution information of each worm detection parameter value of the normal communication state. In addition to the frequency distribution information regarding the normal state, the worm detection parameter setting device 10 can create frequency distribution information based on a communication log indicating the worm state, and set a threshold value based on the frequency distribution information indicating the normal state and the worm state.

The first embodiment where a communication log indicating normal communication is only used will be first described, and then the second embodiment where a communication log indicating normal communication and a communication log indicating worm communication are both used will be described.

### (1) First Embodiment (Using Only Communication Log of Normal Communication)

A communication log indicating normal communication (hereinafter, referred to as normal communication log) of a target network is obtained. The normal communication log may be created before the worm detection parameter setting process or may be obtained by detecting the current communication in real-time.

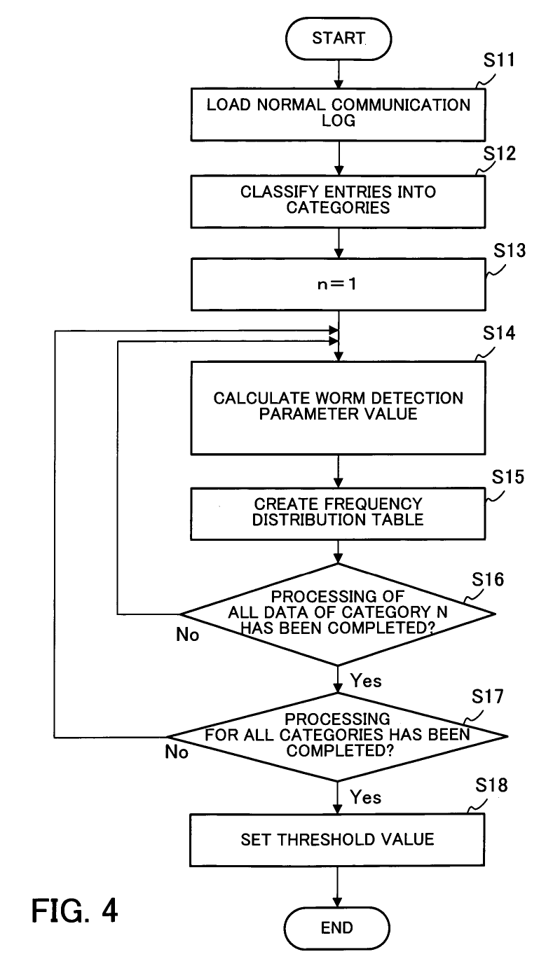

FIG. 4 is a flowchart of a worm detection parameter setting procedure according to the first embodiment.

(Step S11) The log reader 1a loads a normal communication log created within a prescribed time period. Each entry of the normal communication log shows packet information including a source IP address, a destination IP address, a source port number, a destination port number, and a protocol. Each entry of the normal communication log, if previously created, shows time information such as the transmission time of a packet as well.

(Step S12) The log classifier 1b classifies the entries of the obtained normal communication log into categories based on communication contents, such as protocol, service, and flag. For example, when “protocol is TCP, destination port number is 80, and SYN flag is set” is set as a category, corresponding entries are extracted and collected from the normal communication log. In this way, as the categorization items, one or some items can be set. Alternatively, no item may be set so that all entries are treated as one category.

(Step S13) The frequency distribution creator 1C starts to process the entries of n (arbitrary number) kinds of categories, starting with the entries of category 1 (n=1).

(Step S14) The frequency distribution creator 1C calculates a worm detection parameter value per unit time from the entries of category n, for each object of a network unit. Assume now that “the unit time is 10 seconds, the network unit is terminal, and the worm detection parameter is the number of kinds of destination IP addresses”. The frequency distribution creator 1c counts the number of kinds of destination IP addresses from the entries that are created within 10 seconds and indicate the same source IP addresses, thereby calculating a worm detection parameter value. In this connection, in the worm state, an infected terminal transmits to a plurality of destination IP addresses a large number of packets belonging to the same category. Based on this behavior, the number of kinds of destination IP addresses of packets sent from one terminal (the same source IP address) within 10 seconds is counted.

(Step S15) The frequency distribution creator 1c updates a frequency distribution table based on the worm detection parameter value (the number of kinds of destination IP addresses of packets sent from one terminal within 10 seconds) calculated in step S14. The frequency distribution table has the worm detection parameter of class intervals of 5 each, and represents frequency distribution information indicating the appearance frequency in each class interval, in a table. Here, the appearance frequency (appearance number of times) in a class interval corresponding to the worm detection parameter value calculated in step S14 is incremented by one, thereby updating the frequency distribution table.

(Step S16) It is determined whether the processing of all data of the category n is completed. This determination results in No, the process returns back to step S14 to start the processing of entries created within next unit time.

(Step S17) Since the processing of all data of the category n is completed, it is then determined whether the processing of the entries of all categories obtained in step S12 is completed. This determination results in No, n is incremented and the process returns back to step S14 to start the process for the next category.

(Step S18) The threshold derivation unit 1d derives a threshold (a value separating between normal communication and worm communication) for the worm detection parameter from the created frequency distribution table under a predetermined rule.

The above procedure results in obtaining frequency distribution tables and corresponding threshold values, the frequency distribution tables each indicating the number of kinds of destination IP addresses of packets of a category, the packets sent from a terminal within 10 seconds which is a unit time.

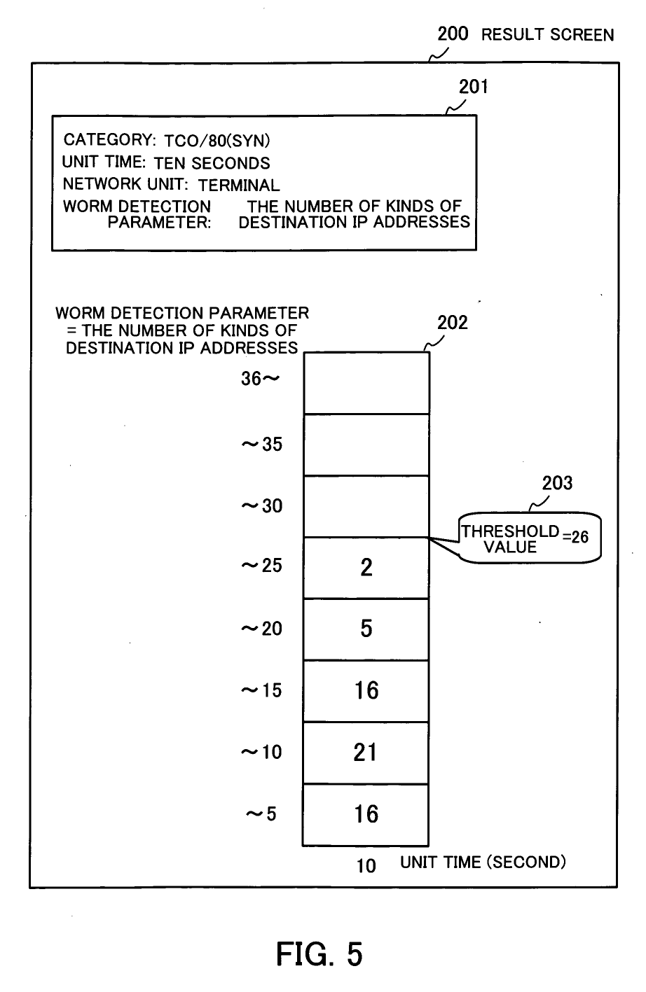

FIG. 5 shows an example of a display screen showing a frequency distribution table and a result according to the first embodiment.

When the output device 3 is a display device, a result screen 20 shows an example of a screen to be displayed on the output device 3, based on display information created by the output unit 1e.

The result screen 200 shows conditions 201 for creating a frequency distribution table, a frequency distribution table 202, and a threshold value 203.

In this figure, the conditions 201 show “protocol is TCP, destination port number is 80, and SYN flag is set” as a category, “10 seconds” as a unit time, “terminal” as a network unit, and “the number of kinds of destination IP addresses” as a worm detection parameter.

The frequency distribution table 202 has the worm detection parameter of class intervals of 5 each, and the number in each class interval indicates how many times (appearance frequency) the number of kinds of destination IP addresses per unit time falls into the class interval, the worm detection parameter being the number of kinds of destination IP addresses. As can be known from this figure, five or less kinds of destination IP addresses are detected 16 times and 6 or more and 10 or less kinds are detected 21 times.

The threshold value 203 is derived under predetermined rules. In this figure, the simplest rule is applied, where one is added to the maximum limit of the class intervals containing values. That is, the threshold value 203 of 26 is derived by adding one to the maximum limit of 25 of a class interval “−25”.

The user checks the result screen 200 whether the threshold value is appropriate, with his/her experiences and knowledge. For example, the user can change the threshold value to a bit higher value by considering the frequency distribution. The threshold value can be changed directly or by changing the rule.

In addition, not only one threshold value is displayed on the result screen 200, but also some kinds of rules can be set and threshold values each derived under each rule can be listed and displayed so that the user can select the most appropriate threshold value.

The result screen 200 is an analysis result of a preset category. In actual, for each category, a frequency distribution table is created and a threshold value is set. This technique provides good detection accuracy but may cause a large number of threshold values and hard management. Therefore, a function of merging the threshold values under a prescribed rule to set one threshold value can be provided.

The prescribed rule to merge threshold values may be “merging of threshold values into the maximum value”, “merging into the minimum value”, “merging into the most threshold value”, or “merging into an intermediate value between the maximum value and the minimum value”. In this embodiment, a rule is appropriately selected depending on the state of a network system. Some kinds of rules may be previously registered so that a user can select from among them. Alternatively, all threshold values are not merged into one representative value, but a threshold value can be determined for every some categories.

As described above, according to the first embodiment, the appearance frequency of packets for each category in the normal communication state is obtained and an appropriate worm detection parameter is derived from the appearance frequency.

(2) Second Embodiment (Using Both Communication Log of Normal Communication and Communication Log of Worm Communication)

In addition to a normal communication log described in the first embodiment, a communication log of worm communication (hereinafter, referred to as worm communication log) is used for deriving a threshold value, thus making it possible to set a more appropriate threshold value.

In this case, both a normal communication log and a worm communication log are obtained. The normal communication log is obtained as described in the first embodiment, and the worm communication log is obtained by actually creating worm communication.

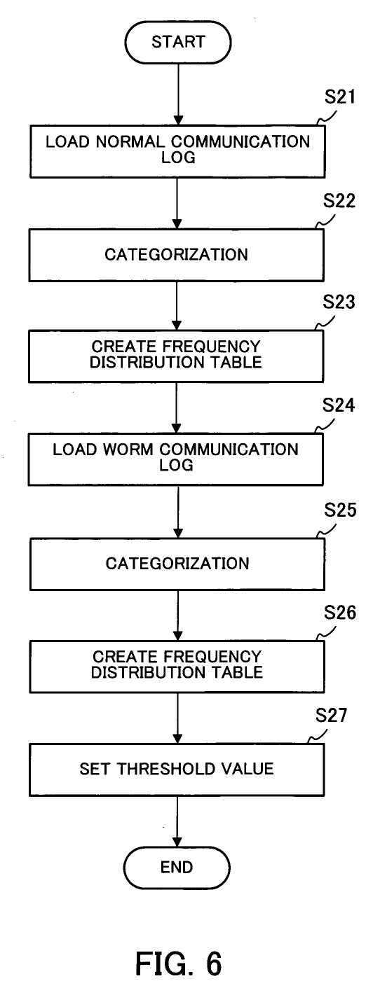

FIG. 6 is a flowchart of a worm detection parameter setting procedure according to the second embodiment.

(Step S21) The log reader 1a loads a normal communication log created within a prescribed time period.

(Step S22) The log classifier 1b classifies the entries of the loaded normal communication log into categories based on communication contents.

(Step S23) The frequency distribution creator 1c creates a frequency distribution table for each category, from the categorized entries.

The process so far is the same as that in the normal communication case of FIG. 4, and thus the frequency distribution table based on the normal communication log is created.

(Step S24) The log reader 1a loads a worm communication log created within a prescribed time period. The entries of the worm communication log have the same format as those of the normal communication log.

(Step S25) The log classifier 1b classifies the entries of the loaded worm communication log into the categories based on the communication contents.

(Step S26) The frequency distribution creator 1c creates a frequency distribution table for each category, based on the categorized entries.

The process so far is the same as that in the normal communication case of FIG. 4, and thus the frequency distribution table based on the worm communication log is created.

(Step S27) A threshold value is derived under a prescribed rule, from the frequency distribution table based on the normal communication log, which was created with the process from step S21 to step S23, and the frequency distribution table based on the worm communication log, which was created with the process from step S24 to step S26.

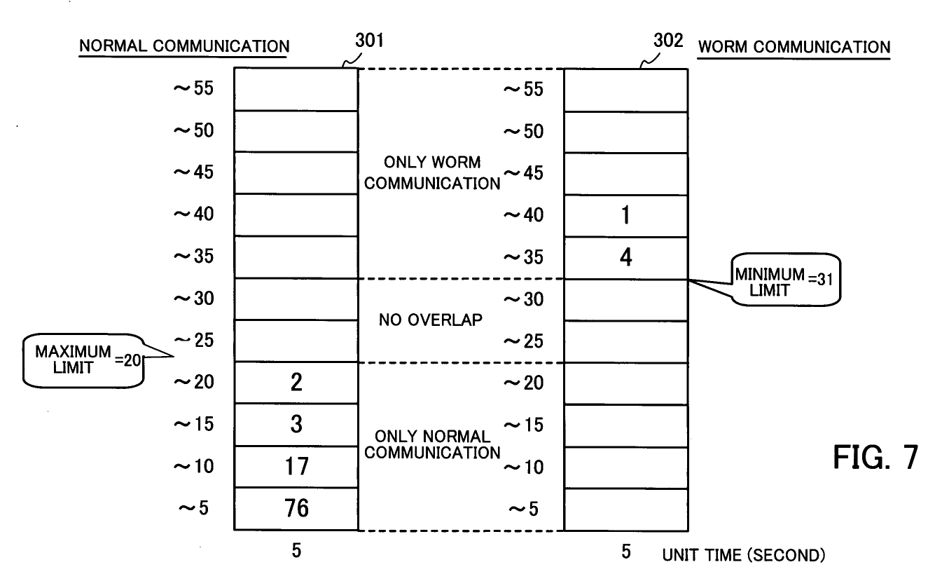

Next explanation is about how to derive a threshold value, with reference to FIG. 7.

The log classifier 1b and the frequency distribution creator 1c create a frequency distribution table 301 based on a normal communication log and a frequency distribution table 302 based on a worm communication log. Note that the vertical direction of the tables shows the number of kinds of destinations of packets of the same category per unit time, that is, worm detection parameter values.

Referring to this figure, in the normal communication, each class interval up to a class interval “−20” contains a value as an appearance frequency. On the other hand, in the worm communication, each class interval “−35” or over contains a value. That is, the maximum limit detected from the frequency distribution table of the normal communication is 20 while the minimum limit detected from the frequency distribution table of the worm communication is 31.

Assume that a rule to derive a threshold value is that “a threshold value is an intermediate value between (the maximum limit of class intervals each containing a value in a frequency distribution table of normal communication +1) and (the minimum limit of class intervals each containing a value in a frequency distribution table of worm communication −1)”. Since the maximum limit is recognized as 20 and the minimum limit is recognized as 31, a threshold value of 26 is derived. Here, a broken number is rounded up.

Thus obtained threshold value and the frequency distribution tables based on the normal communication and the worm communication are output from the output unit 1e to the output device 3 in order to show the user. The user checks the information whether the threshold value is appropriate.

The threshold derivation rule is not limited to the above rule and another rule can be adopted.

Further, in this embodiment, the worm communication log is obtained by actually transmitting worm communication. However, since known worms' behaviors are clear, worm communication information including a category of packets to be transmitted from a worm-infected terminal and transmission intervals can be easily obtained. By applying this worm communication information to network environment information, the appearance frequency of each worm detection parameter value can be calculated. Therefore, in place of the process from step S24 to step S26 in FIG. 6, a frequency distribution table may be created based on the worm communication information and the network environment information.

Still further, such a frequency distribution table can be previously created by another device.

Referring to FIG. 7, the frequency distribution of the normal communication and the frequency distribution of the worm communication do not overlap. However, the obtained frequency distributions may overlap.

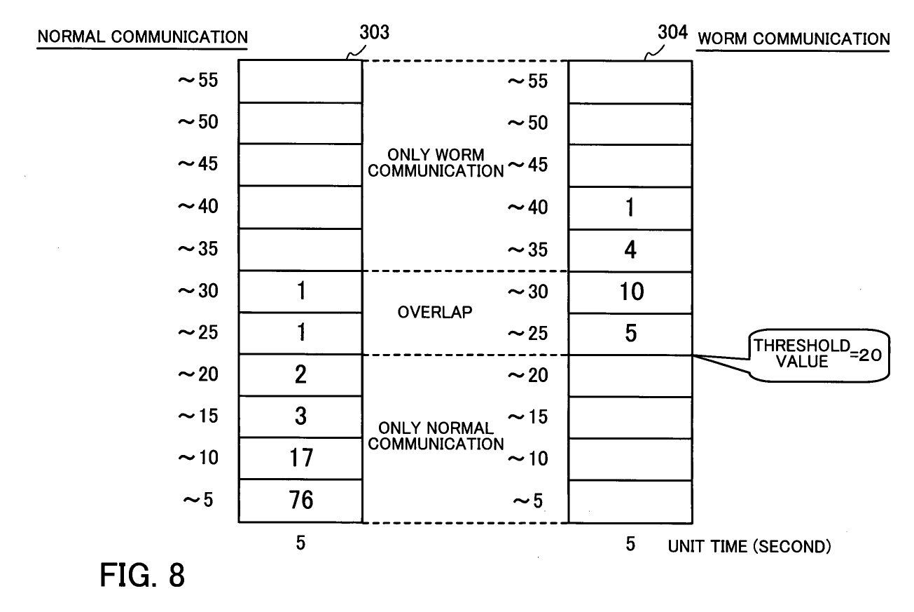

FIG. 8 shows an example of deriving a threshold value in a case where the frequency distributions of the normal communication and the worm communication overlap, according to the second embodiment. The vertical direction of the table shows the same index as that of FIG. 7.

Referring to this figure, the maximum class interval containing a value in the normal communication is recognized as a class interval “−30” from a frequency distribution table 303. The minimum class interval containing a value in the worm communication is recognized as a class interval “−25” from a frequency distribution table 304. That is, the frequency distributions of the normal communication and the worm communication overlap in the class intervals “−25” and “−30”.

If the above rule (an intermediate value between (the maximum limit +1) and (the minimum limit −1) is applied to this case, a threshold value of 26 is derived from the maximum limit of 30 and the minimum limit of 21.

Thus obtained threshold value and the frequency distribution tables are provided to the user. If a threshold value of 26 is used, a range of worm detection parameter values in worm communication cannot be all covered. To detect worms without fail, the minimum limit obtained from the frequency distribution of the worm communication is recommended as a threshold value.

For such a different case, a policy is previously set, which directs using of a different rule, not the simple rule of FIG. 7 (an intermediate value between (the maximum limit +1) and (the minimum limit −1)), in order to set a more appropriate threshold value.

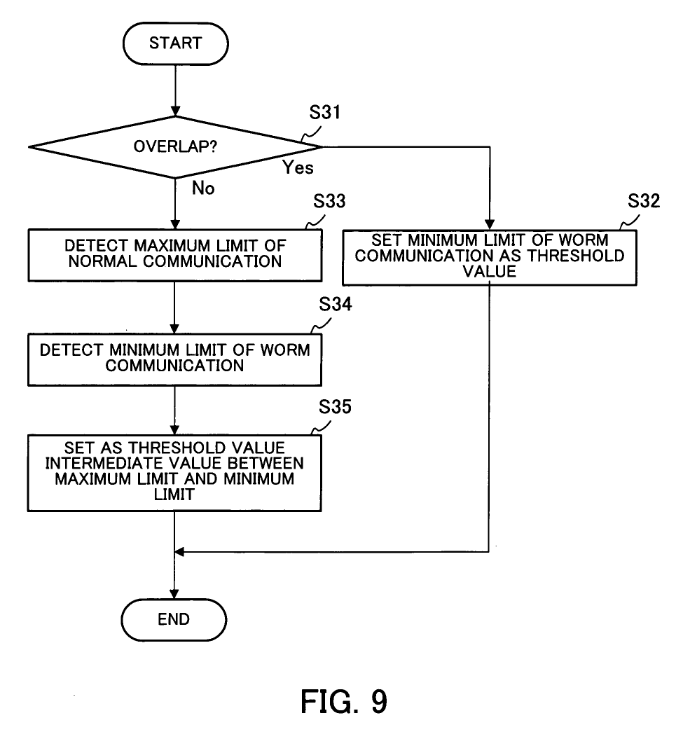

FIG. 9 is a flowchart showing an example of a procedure for deriving a threshold value under a threshold derivation policy according to the second embodiment. In this figure, a different threshold derivation rule is selected based on whether the frequency distributions of the normal communication and the worm communication overlap.

(Step S31) The frequency distribution tables of the normal communication and the worm communication are compared to determine whether their frequency distributions overlap. This determination results in No, the process goes on to step S33.

(Step S32) Since the frequency distributions overlap, the minimum limit of the frequency distribution table of the worm communication is set as a threshold value, and this procedure is completed.

(Step S33) Since the frequency distributions do not overlap, the maximum limit of the class intervals each containing a value in the frequency distribution table of the normal communication is detected.

(Step S34) The minimum limit of the class intervals each containing a value in the frequency distribution table of the worm communication is detected.

(Step S35) An intermediate value between the maximum limit of the normal communication, which was obtained in step S33, and the minimum limit of the worm communication, which was obtained in step S34, is set as a threshold value, and this procedure is completed.

According to the above procedure, the minimum limit of worm communication is set as a threshold value in a case where the frequency distributions of the normal communication and the worm communication overlap, and an intermediate value between the maximum limit of the normal communication and the minimum limit of the worm communication is set in a case where the frequency distributions do not overlap.

Note that the above threshold derivation policy is just an example. Alternatively, another policy to be considered is to execute a process (corresponding to feedback of threshold value) of obtaining the minimum limit of the worm detection parameter for the worm communication based on a worm communication log and setting an intermediate value between the minimum limit and the current threshold value as a new threshold value, or a process (corresponding to feedback of threshold value) of obtaining the maximum limit of the worm detection parameter in the normal communication based on a normal communication log and setting an intermediate value between the maximum limit and the current threshold value as a new threshold value. These processes enable maintenance of a threshold value. That is, a threshold value is changed to a more appropriate one (suitable for the current communication amount) before decreasing its reliance.

In addition to these, a desired threshold derivation policy can be set. As another policy, a threshold value can be determined based on detection accuracy that is considered from threshold values. Various indexes of detection accuracy can be considered. Here, an excess detection rate of erroneously identifying normal hosts as worm-infected hosts and a detection failure rate of erroneously identifying worm-infected hosts as normal hosts are used as detection accuracy indexes.

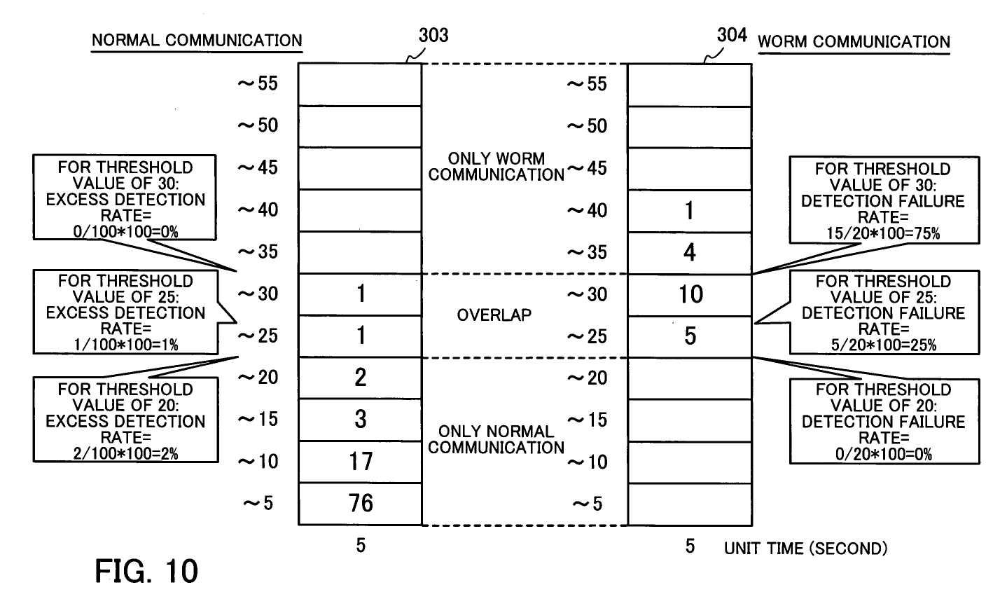

FIG. 10 shows an example of deriving a threshold value based on detection accuracy according to the second embodiment. A frequency distribution table 303 of the normal communication and a frequency distribution table 304 of the worm communication are represented in the same way of those of FIG. 8.

Here an excess detection rate and a detection failure rate are calculated by using as temporal threshold values the border values 20, 25, 30 separating between class intervals “21-25” and “26-30” where the normal communication and the worm communication overlap.

The excess detection rate is a rate of the total appearance frequency of the frequency distribution table of the normal communication and the total appearance frequency up to a threshold value in the normal communication. That is, the excess detection rate is calculated based on the frequency distribution table of the normal communication with the following equation (1).
Excess detection rate=(total appearance frequency up to threshold value in normal communication)/(total appearance frequency in normal communication)*100 (1)

Since the excess detection rate is a rate of erroneously identifying normal communication as worm communication, the total appearance frequency up to a threshold value is calculated by adding the values in the class intervals greater than a temporal threshold value in the frequency distribution table of normal communication.

On the other hand, the detection failure rate is a rate of the total appearance frequency of the frequency distribution table of the worm communication and the total appearance frequency up to a threshold value in the worm communication. That is, the detection failure rate is calculated based on the frequency distribution table of the worm communication with the following equation (2).
Detection failure rate=(total appearance frequency up to threshold value in worm communication)/(total appearance frequency in worm communication)*100 (2)

Since the detection failure rate is a rate of missing worm detection, the total appearance frequency up to a threshold value is calculated by adding the values of class intervals lower than a threshold value of the frequency distribution table of the worm communication.

In a case of a threshold value of 25, the appearance frequency greater than the threshold value in the normal communication is 1 and the total appearance frequency in the normal communication is 100. Therefore, the excess detection rate is derived from the equation (1): 1/100*100=1%.

On the other hand, in a case of the threshold value of 25, the total appearance frequency lower than the threshold value in worm communication is 5 and the total appearance frequency in the worm communication is 20. Therefore, the detection failure rate is derived from the equation (2): 5/20*100=25%.

Similarly, an excess detection rate and a detection failure rate can be calculated for each threshold value 30, 20.

The excess detection rate and the detection failure rate for each threshold value are evaluated with an evaluation expression, in order to select a threshold value that satisfies the evaluation expression. When some threshold values satisfy the evaluation expression, a threshold value with the best evaluation result is selected.

A following expression (3) is just an example:
A<0.05(5%) && B<0.05 (5%) (3),

where an excess detection rate and a detection failure rate are taken as A and B, respectively, and && represents an AND operation. That is, in this expression (3), it is determined whether A is 5% or less and B is 5% or less.

A following is another evaluation expression (4):
B<0.05 (5%)∥AB<0.008 (4),

where ∥ represents an OR operation. That is, it is determined whether B is 5% or less or a product of A and B is 0.008 or less.

Referring to FIG. 10, by evaluating the threshold values 30, 25 and 20 with the evaluation expression (3), it is recognized that only the threshold value 20 satisfies the expression (3) and can be identified as the most appropriate.

If any threshold value does not satisfy the evaluation expression, this information is provided to the user, so that the user can select a threshold value. Even there is a threshold value satisfying the evaluation expression, it can be designed that the user can made a final decision.

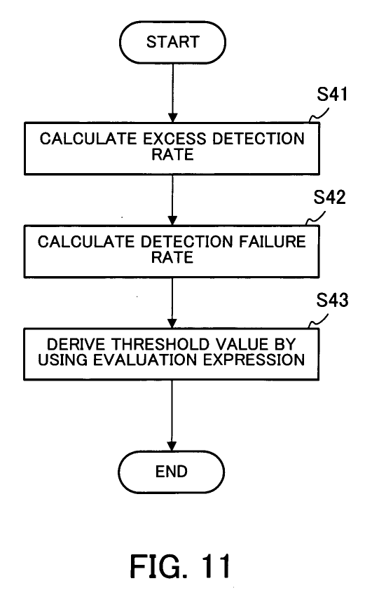

FIG. 11 is a flowchart of a threshold derivation procedure based on detection accuracy, according to the second embodiment.

(Step S41) An excess detection rate is calculated for each class interval based on the frequency distribution table of the normal communication. Although excess detection rates for all class intervals can be calculated, only a threshold value separating between the normal communication and the worm communication is desired to be obtained. Therefore, it is only necessary to use as temporal threshold values the limit values of class intervals where the normal communication and the worm communication overlap and calculate an excess detection rate for each threshold value.

(Step S42) A detection failure rate is calculated for each class interval based on the frequency distribution table of the worm communication. Similarly to step S41, it is only necessary to use as temporal threshold values the limit values of class intervals where the normal communication and the worm communication overlap and calculate a detection failure rate for each threshold value.

(Step S43) The excess detection rates calculated in step S41 and the detection failure rate calculated in step S42 are applied to an evaluation expression (3), (4) to determine an appropriate threshold value. For example, the expression (3) is first tried, and if an appropriate threshold value cannot be selected, the expression (4) is next applied, thereby selecting a more appropriate threshold value. In this way, sequential evaluation may be conducted.

With the above procedure, in a case where the frequency distribution of the normal communication and the frequency distribution of the worm communication overlap, an appropriate threshold value can be obtained by evaluating an excess detection rate and a detection failure rate for each of threshold values. When the frequency distributions do not overlap as shown in FIG. 7, an excess detection rate and a detection failure rate are both 0%, and thus such evaluation is not required.

Further, it can be designed so that, not one unit time but some choices of unit time are set, a frequency distribution table based on the normal communication and a frequency distribution table based on the worm communication are created for each choice of unit time, and an appropriate threshold value and unit time are selected.

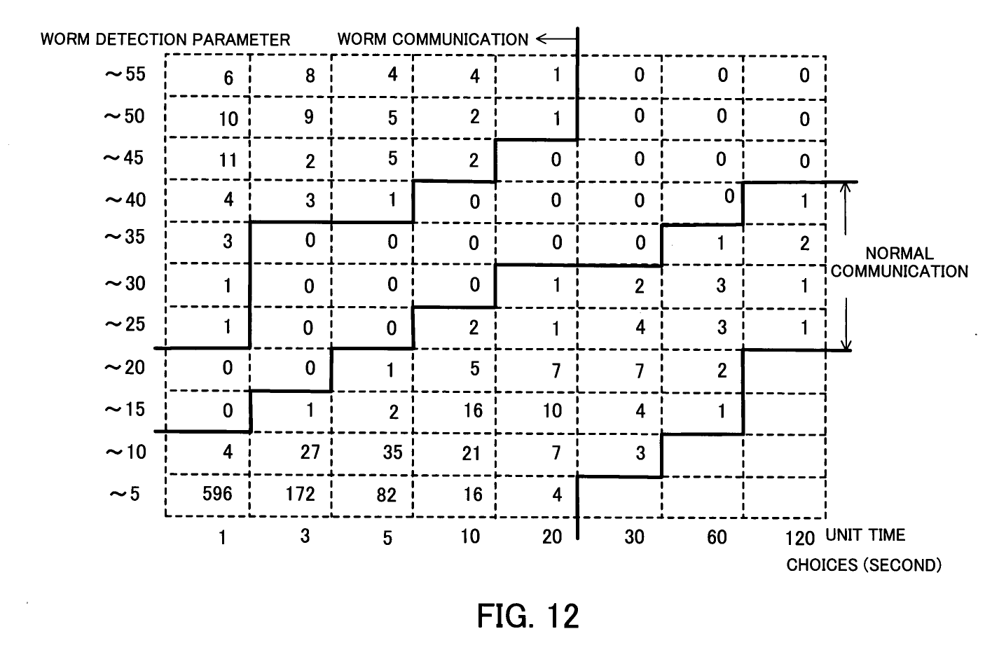

FIG. 12 shows an example of deriving a threshold value from frequency distribution tables created for some choices of unit time, according to the second embodiment. The frequency distribution table of this figure is obtained by combining frequency distribution tables of the normal communication and the worm communication created for the choices of unit time. The vertical direction represents worm detection parameter values and the horizontal direction represents the choices of unit time.

For each choice of unit time, class intervals of a lower part (smaller worm detection parameter values) represent a frequency distribution of the normal communication and class intervals of an upper part (larger worm detection parameter values) represent a frequency distribution of the worm communication. For example, in a case of a unit time of one second, a range of worm detection parameter values from a class interval “−5” to a class interval “−10” is a frequency distribution of normal communication while a range from a class interval “−25” to a class interval “−55” is a frequency distribution of worm communication.

The threshold derivation unit 1d analyzes the frequency distribution table to derive an appropriate threshold value and unit time. This derivation procedure may be previously incorporated into a program, or may be described in a policy so as to realize the derivation procedure by executing the policy.

An example of the derivation procedure will be now described.

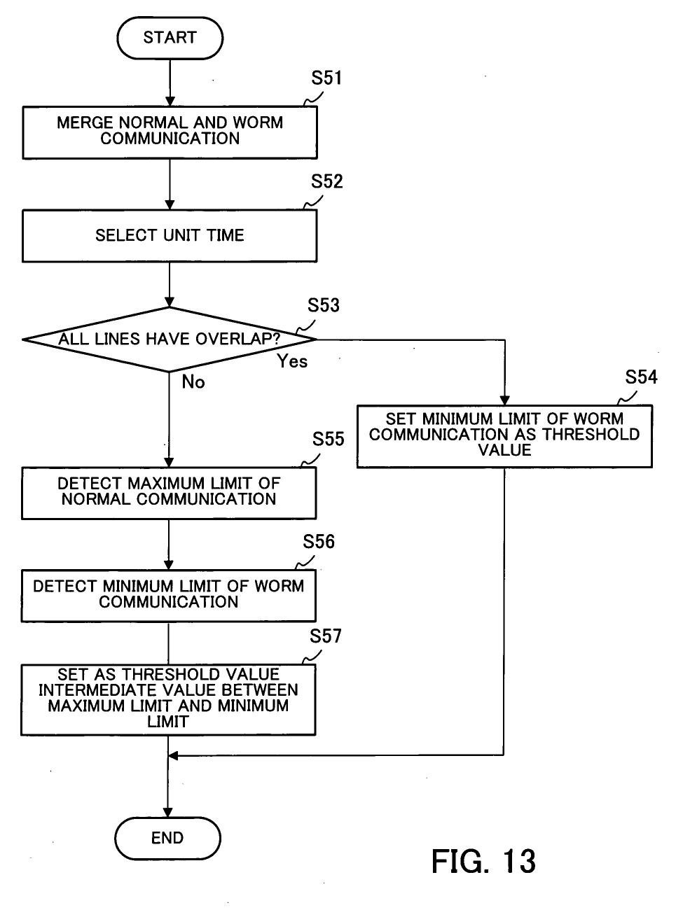

FIG. 13 is a flowchart of a procedure of deriving a threshold value from frequency distribution tables created for some choices of unit time, according to the second embodiment.

(Step S51) Frequency distribution tables for the choices of unit time based on the normal communication log and frequency distribution tables for the choices of unit time based on the worm communication log are merged to create a frequency distribution table as shown in FIG. 12.

(Step S52) An appropriate unit time is selected. Specifically, with reference to the frequency distribution table, the line of a unit time where the normal communication and the worm communication do not overlap with the largest interval is selected. If all choices of unit time provide overlap, no unit time is selected. If some choices of unit time provide the same interval, one of them is selected. An order of priority, such as an order from the shortest unit time, can be set so as to select a unit time in the order. In the frequency distribution table of FIG. 12, a unit time of 1 second has 2 intervals, a unit time of 3 seconds has 4 intervals, a unit time of 5 seconds has 3 intervals, a unit time of 10 seconds has 3 intervals, and a unit time of 20 seconds has 3 intervals. Therefore, a unit time of 3 seconds with the largest interval is selected.

(Step S53) In the selection of a unit time in step S52, it is determined whether there is a line that does not have overlap, that is, whether selection can be made. This determination results in Yes, the process goes on to step S55.

(Step S54) Since all lines have overlap and any unit time cannot be selected, a certain line is selected, a minimum limit of frequency distribution of the worm communication in the line is set as a threshold value, and this procedure is completed. It should be noted that an excess detection rate and a detection failure rate can be calculated to obtain an appropriate threshold value at this time.

(Step S55) Since there is a line that does not have overlap and a unit time can be selected, the maximum limit of frequency distribution of the normal communication of the unit time is detected.

(Step S56) The minimum limit of the frequency distribution of the worm communication of the unit time is detected.

(Step S57) An intermediate value between the maximum limit of the normal communication obtained in step S55 and the minimum limit of the worm communication obtained in step S56 is calculated and set as a threshold value.

With the above procedure, an appropriate unit time and an appropriate threshold value are derived. Thus obtained unit time and threshold value are provided to the user together with the frequency distribution table shown in FIG. 12. The user can make a final decision of an appropriate unit time and threshold value based on the frequency table and with own knowledge and experiences.

The worm detection parameter setting process according to the embodiments has been described. Note that it is only necessary to apply this process for setting an appropriate worm detection parameter when a system starts or a system is changed.

Further, as shown in FIG. 2, the worm detection parameter setting device is connected to the target network segments over a network, and can be designed to obtain a communication log of each target network segment in real-time, calculate an appropriate worm detection parameter, and update the worm detection parameter registered in the worm detection/interruption device of the target network segment online.

The processing functions described above can be realized by a computer. In this case, a program is prepared, which describes processes for the functions to be performed by the worm detection parameter setting device. The program is executed by a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include Digital Versatile Discs (DVD), DVD-Random Access Memories (DVD-RAM), Compact Disc Read-Only Memories (CD-ROM), CD-R (Recordable)/RW (ReWritable), etc. The magneto-optical recording media include Magneto-Optical disks (MO) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

According to this invention, the categorized entries of a communication log is analyzed to create frequency distribution information of each worm detection parameter value for each object of a prescribed network unit, and a threshold value to be used for determining that a worm is propagating is derived based on the frequency distribution information. Then the worm detection parameter including the threshold value is provided to a user together with the frequency distribution information. Therefore, the user can determine based on the received frequency distribution information whether the derived threshold value is appropriate, thus making it possible to set an appropriate worm detection parameter.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium recording a worm detection parameter setting program for setting a worm detection parameter to be used for determining whether a worm is propagating, the worm detection parameter setting program causing a computer to function as:
log classification means for classifying entries of a communication log created within a prescribed time period, into preset categories based on communication contents when the communication log is loaded;
frequency distribution creation means for calculating a value of the worm detection parameter per preset unit time, for each object of a preset network unit, based on the entries of each of the preset categories, counting an appearance frequency of each value of the worm detection parameter, and creating frequency distribution information;
threshold derivation means for analyzing the frequency distribution information created by the frequency distribution creation means, and deriving a threshold value for the worm detection parameter to be used for determining whether the worm is propagating; and
output means for outputting to a prescribed output device the worm detection parameter including the threshold value derived, together with the frequency distribution information created by the frequency distribution creation means.

2. The computer-readable recording medium recording the worm detection parameter setting program according to claim 1, wherein the frequency distribution creation means calculates the value of the worm detection parameter per the preset unit time for each object of the preset network unit, by counting a number of entries regarding the each object of the preset network unit per the preset unit time, from the entries of the each of the preset categories.

3. The computer-readable recording medium recording the worm detection parameter setting program according to claim 1, wherein the worm detection parameter is an information item to be used for determining whether a worm-infected terminal transmits a large number of packets, the information item including a number of packets per the preset unit time, a data transfer amount, and a number of kinds of destination addresses.

4. The computer-readable recording medium recording the worm detection parameter setting program according to claim 1, wherein the frequency distribution creation means creates normal frequency distribution information regarding normal communication based on a normal communication log including no worm communication,
the threshold derivation means obtains worm frequency distribution information regarding worm communication, and derives the threshold value based on the normal frequency distribution information created by the frequency distribution creation means and the worm frequency distribution information, and
the output means outputs to the output device the normal frequency distribution information and the worm frequency distribution information together with the threshold value.

5. The computer-readable recording medium recording the worm detection parameter setting program according to claim 4, wherein the frequency distribution creation means counts the appearance frequency of the each value of the worm detection parameter, based on prepared worm communication information on worm's behavior and network environment information on a target network, and creates the worm frequency distribution information.

6. The computer-readable recording medium recording the worm detection parameter setting program according to claim 4, wherein the log classification means loads a worm communication log of the worm communication created within the preset time period, and classifies worm entries of the worm communication log into the preset categories, and
the frequency distribution creation means calculates the value of the worm detection parameter per the preset unit time for the each object of the preset network unit, based on the worm entries of the each of the preset categories, counts the appearance frequency of the each value of the worm detection parameter, and creates the worm frequency distribution information.

7. The computer-readable recording medium recording the worm detection parameter setting program according to claim 4, wherein the threshold derivation means sets as the threshold value an intermediate value between a first threshold value derived from the normal frequency distribution information and a second threshold value derived from the worm frequency distribution information, based on the normal frequency distribution information and the worm frequency distribution information, when frequency distributions of the normal frequency distribution information and the worm frequency distribution information do not overlap.

8. The computer-readable recording medium recording the worm detection parameter setting program according to claim 7, wherein the threshold derivation means sets as the threshold value the intermediate value between the first threshold value and the second threshold value with taking as the first threshold value a maximum limit of the worm detection parameter detected from the normal frequency distribution information and taking as the second threshold value a minimum limit of the worm detection parameter detected from the worm frequency distribution information.

9. The computer-readable recording medium recording the worm detection parameter setting program according to claim 4, wherein the threshold derivation means sets as the threshold value a minimum limit of the worm detection parameter detected from the worm frequency distribution information, based on the normal frequency distribution information and the worm frequency distribution information, when frequency distributions of the normal frequency distribution information and the worm frequency distribution information overlap.

10. The computer-readable recording medium recording the worm detection parameter setting program according to claim 4, wherein the threshold derivation means sets a plurality of temporal threshold values based on the normal frequency distribution information and the worm frequency distribution information, calculates detection accuracy of the worm communication for a case where each of the plurality of temporal threshold values is applied, evaluates the detection accuracy calculated for the each of the plurality of temporal threshold values, with a prescribed evaluation expression, and selects an appropriate temporal threshold value satisfying the prescribed evaluation expression as the threshold value.

11. The computer-readable recording medium recording the worm detection parameter setting program according to claim 10, wherein the threshold derivation means calculates an excess detection rate of erroneously determining that the worm is propagating, based on the normal frequency distribution information and each of the plurality of temporal threshold values, and calculates a detection failure rate of missing detection of the worm based on the worm frequency distribution information and each of the plurality of temporal threshold values.

12. The computer-readable recording medium recording the worm detection parameter setting program according to claim 10, wherein the output means outputs each of the plurality of temporal threshold values and the detection accuracy calculated for each of the plurality of temporal threshold values, together with the normal frequency distribution information and the worm frequency distribution information.

13. The computer-readable recording medium recording the worm detection parameter setting program according to claim 4, wherein the frequency distribution creation means creates and combines the normal frequency distribution information and the worm frequency distribution information for each of preset some choices of unit time, and
the threshold derivation means selects as the preset unit time one of the preset some choices of unit time providing a clear border between frequency distributions of the normal communication and the worm communication, based on the frequency distribution information obtained by combining the normal frequency distribution information and the worm frequency distribution information for the each of the preset some choices of unit time.

14. The computer-readable recording medium recording the worm detection parameter setting program according to claim 13, wherein the threshold derivation means selects the one of the preset some choices of unit time providing a largest interval between a maximum limit of the worm detection parameter detected from the normal frequency distribution information and a minimum limit of the worm detection parameter detected from the worm frequency distribution information.

15. The computer-readable recording medium recording the worm detection parameter setting program according to claim 1, wherein the threshold derivation means derives some threshold values each for the each of the preset categories, and determines a representative threshold value from the some threshold values created for the preset categories, under a preset rule.

16. The computer-readable recording medium recording the worm detection parameter setting program according to claim 1, wherein the threshold derivation means derives the threshold value under a threshold determination policy describing a preset procedure to derive the threshold value.

17. The computer-readable recording medium recording the worm detection parameter setting program according to claim 1, wherein the worm detection parameter program causes the computer to obtain the communication log of a target network at prescribed timing in real-time, execute a process from categorization by the log classification means to creation of the frequency distribution information by the frequency distribution creation means and derivation of the threshold value by the threshold derivation means, and update the threshold value registered in a device managing the target network.

18. The computer-readable recording medium recording the worm detection parameter setting program according to claim 1, wherein the communication log created when the worm is propagating is obtained and fed back to a previously obtained threshold value separating between normal communication and worm communication for the worm detection parameter, to correct the previously obtained threshold value.

19. The computer-readable recording medium recording the worm detection parameter setting program according to claim 1, wherein the communication log of normal communication is obtained and fed back to a previously obtained threshold value separating the normal communication and worm communication for the worm detection parameter, to correct the previously obtained threshold value.

20. A worm detection parameter setting device for setting a worm detection parameter to be used for determining whether a worm is propagating, comprising:
log classification means for classifying entries of a communication log created within a prescribed time period, into preset categories based on communication contents when the communication log is loaded;
frequency distribution creation means for calculating a value of the worm detection parameter per preset unit time, for each object of a preset network unit, based on the entries of each of the preset categories, counting an appearance frequency of each value of the worm detection parameter, and creating frequency distribution information;
threshold derivation means for analyzing the frequency distribution information created by the frequency distribution creation means, and deriving a threshold value for the worm detection parameter to be used for determining whether the worm is propagating; and
output means for outputting to a prescribed output device the worm detection parameter including the threshold value derived, together with the frequency distribution information created by the frequency distribution creation means.

21. A worm detection parameter setting method for setting a worm detection parameter to be used for determining whether a worm is propagating, wherein:
log classification means classifies entries of a communication log created within a prescribed time period, into preset categories based on communication contents when the communication log is loaded;
frequency distribution creation means calculates a value of the worm detection parameter per preset unit time, for each object of a preset network unit, based on the entries of each of the preset categories, counts an appearance frequency of each value of the worm detection parameter, and creates frequency distribution information;
threshold derivation means analyzes the frequency distribution information created by the frequency distribution creation means, and derives a threshold value for the worm detection parameter to be used for determining whether the worm is propagating; and
output means outputs to a prescribed output device the worm detection parameter including the threshold value derived, together with the frequency distribution information created by the frequency distribution creation means.
